(19) United States
(12) Patent Application Publication
(10) Pub. No.: US 2006/0282540 A1
(43) Pub. Date: Dec. 14, 2006

(54) File server device, communication management server device, and network system including the file server device and the communication management server device

(75) Inventor: Yoshifumi Tanimoto, Hirakata-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/432,480

(22) Filed: May 12, 2006

(30) Foreign Application Priority Data
Jun. 8, 2005 (JP) 2005-168294

(51) Int. Cl. G06F 15/16

(52) U.S. Cl. 709/228

(57) ABSTRACT

A file server device includes a communication function using a call control protocol such as a SIP, a reply unit and an access accepting unit. When receiving an “INVITE” message, the reply unit returns a response message including information necessary for accessing an object stored in the file server device. The access accepting unit establishes a data session with a transmitter of the “INVITE” message and accepts access to the object stored in the file server device in the established data session.

### BACKGROUND OF THE INVENTION

1. Field of the Invention

The present invention relates to a file server device which accepts access to a file or the like by using a call control protocol such as the Session Initiation Protocol (SIP), a communication management server such as a SIP server which controls a call control, and a network system including the file server device and the communication management server device.

2. Description of the Related Art

In a computer network of a company or the like, since a plurality of users share a file or the like over a network, a file server device is provided in many cases. In a company including a plurality of groups such as departments, there are cases in which a file server device is installed in each group for sharing the file or the like. In such cases, user account information of each group is registered in the file server device, and only a terminal device having the registered user account information can use the file server device.

There are cases in which all the terminal devices of users sharing the file server device are connected to the same Local Area Network (LAN). However, in a large company having branch offices at remote locations, a Wide Area Network (WAN) becomes necessary for sharing the file server device. In such a case, in order to ensure security, it is necessary to construct a dedicated network such as an intranet, and a Virtual Private Network (VPN) or the like, and to access the file server device through the secure networks.

When sharing a file server device within the same LAN, just a user account of a user to be permitted access can be registered in the file server device. However, when registering a user account of a user sharing the file server device via the WAN or the VPN or the like, in addition to the registration operation of the user account of the user to be permitted access, a network setting is also required to be made for each user account. For example, a setting of a firewall and a Network Address Translation (NAT) or the like is required to be set for each user account registered as a common user, not only for the file server device. Therefore, in case of sharing the file server device via the WAN or the VPN or the like, a great amount of time and effort must be spent for the setting operation. As a result, it is difficult to control the sharing of the files or to enable the files to be accessed from a remote location via the WAN or the like within the same organization.

When moving the file server device, many setting operations are also required. For example, an Internet Protocol (IP) address of the file server device is required to be changed. As a result, it is also difficult to easily and flexibly move the file server device.

### SUMMARY OF THE INVENTION

In order to overcome the problems described above, an advantage of the present invention is to provide a file server device and a communication management server device which can reduce a burden of a setting operation required when newly installing or moving the file server device in case the file server device is shared among a plurality of terminal devices via a WAN or a VPN.

According to a preferred aspect of the present invention, a file server device includes a communication function using a call control protocol. The file server device includes a reply unit and an access accepting unit. When receiving a data session initiation request by the call control protocol, the reply unit returns a response message including information necessary for accessing an object stored in the file server device in a response message. The access accepting unit establishes a data session with a requestor that has transmitted the data session initiation request, and accepts access to the object stored in the file server device over the established data session.

The information necessary for accessing the object stored in the file server device includes an access port number. The file server device also includes an access port opening and closing unit. When establishing the data session, the access port opening and closing unit changes a state of the access port number described in the response message into an opened state. When terminating the data session, the access port opening and closing unit changes the opened state of the access port number into a closed state.

The access port opening and closing unit updates the access port number to be provided under the opened state each time when receiving the data session initiation request.

The file server device also includes a notification unit. When receiving the data session initiation request, in case a communication load of the file server device is a prescribed value or more, the notification unit carries out a notification to the requestor that has transmitted the data session initiation request. The notification includes a fact that a different device will accept the access in place of the file server device, and destination information of the different device having a copy of the object stored in the file server device.

According to another preferred aspect of the present invention, a communication management server device includes a memory unit and a forwarding unit. The memory unit stores account information of a file server device and account information of a plurality of devices sharing the file server device into a same table, and memorizes the table. In case of receiving a data session initiation request addressed to the file server device, only when the account information of the requestor and the account information of the file server device are stored in the same table, the forwarding unit forwards the data session initiation request.

According to the preferred aspects of the present invention, when a plurality of client devices share the file server device, the communication management device carries out an authentication when the client device accesses the file server device. Therefore, the file server device is not required to store the account information (authentication information) of the client device. When newly installing or moving the file server device, just the account information of the file server device is required to be registered or changed in the communication management device. The account information of the client device is not required to be registered or changed in the file server device. In particular, when a plurality of client devices share the file server device via the WAN or the VPN, if a network for using the call control is previously constructed, a separate setting operation for the network becomes unnecessary. The burden of the setting operation carried out when newly installing or moving the file server device can be reduced considerably.

According to the file server device of the preferred aspect of the present invention, as the access port number necessary for accessing the object stored in the file server device, a random access port number is notified at a response to the data session initiation request. The access port is opened only when there is an access, and the access port is closed when there is no access. As a result, security is improved.

According to the file server device of the preferred aspect of the present invention, the access port number to be opened is updated each time when receiving the data session initiation request. As a result, security is improved even more.

According to the file server device of the preferred aspect of the present invention, when the communication load of the file server device is a prescribed value or more, a different device accepts the access in place of the file server device. As a result, the communication load can be dispersed.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates a state in which file server devices, a SIP server device (communication management server device) and client devices or the like are connected to a network according to a first preferred embodiment of the present invention.

FIG. 2 is a functional block diagram of a file server device according to the first preferred embodiment of the present invention.

FIG. 3 is a functional block diagram of a SIP server device (communication management server device) according to a first preferred embodiment of the present invention.

FIG. 4 is a flowchart illustrating a processing operation executed when the SIP server device (communication management server device) receives a data session initiation request according to the first preferred embodiment of the present invention.

FIG. 5 is a flowchart illustrating a processing operation executed when a primary file server device receives a data session initiation request according to a preferred embodiment of the present invention.

FIG. 6 is a flowchart illustrating a processing operation executed when a secondary file server device receives a data session initiation request according to a preferred embodiment of the present invention.

FIG. 7 is a sequence diagram illustrating a communication procedure formed between a file server device, a SIP server device (communication management server device) and a client device according to a preferred embodiment of the present invention.

FIG. 8 is a sequence diagram illustrating a communication procedure formed between the file server device, the SIP server device (communication management server device) and the client device according to a preferred embodiment of the present invention.

FIG. 9 is a sequence diagram illustrating a communication procedure formed between the file server devices, the SIP server device (communication management server device) and the client device according to the first preferred embodiment of the present invention.

FIG. 10 is a sequence diagram illustrating a communication procedure formed between the file server devices, a SIP server device (communication management server device) and the client device according to a second preferred embodiment of the present invention.

FIG. 11 is a flowchart illustrating a processing operation executed when the SIP server device (communication management server device) receives a data session initiation request according to the second preferred embodiment of the present invention.

FIG. 12 is a functional block diagram of the SIP server device (communication management server device) according to the second preferred embodiment of the present invention.

### DETAILED DESCRIPTION OF PREFERRED EMBODIMENTS

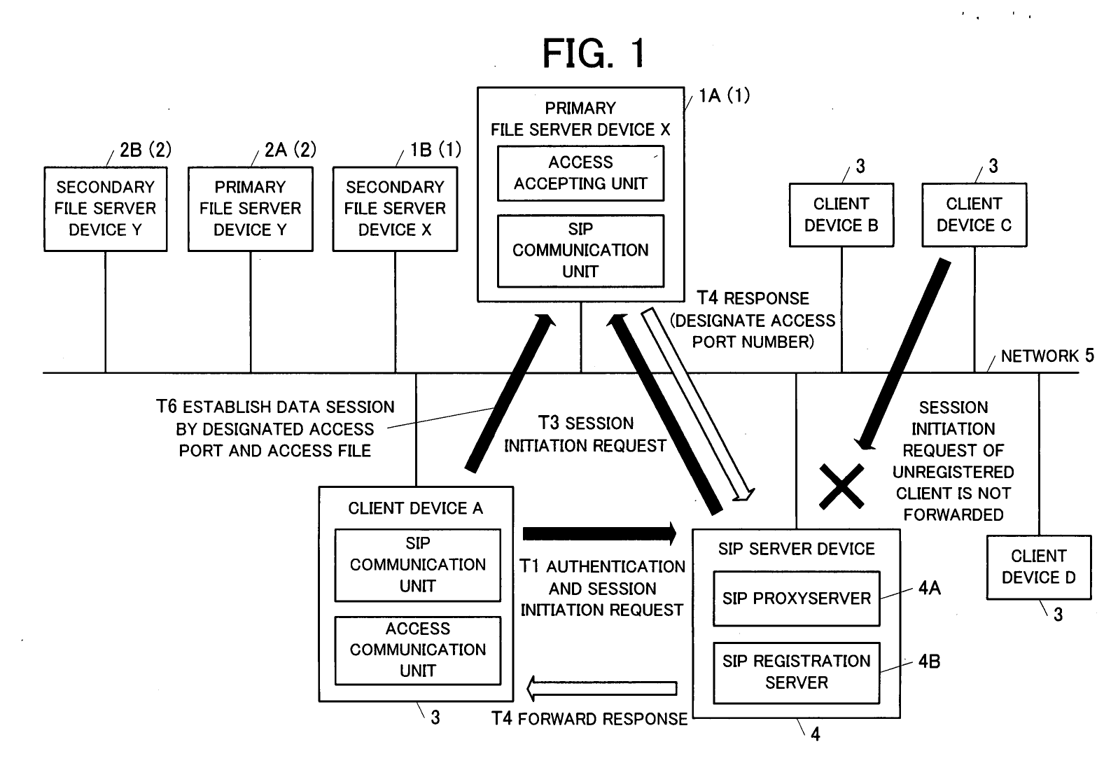

A description will be made of a first preferred embodiment of the present invention. FIG. 1 illustrates a state in which file server devices 1 and 2, client devices 3, and a communication management server device 4 or the like are connected to a network 5 according to the first preferred embodiment of the present invention.

The file server devices 1 and 2 are primary file server devices 1A and 2A and secondary file server devices 1B and 2B. The secondary file server devices 1B and 2B respectively include a copy of an object (for example, a file, a directory) stored in the primary file server devices 1A and 2A. The object such as the file and the directory stored in the primary file server devices 1A and 2A and the object stored in the secondary file server devices 1B and 2B are mirrored with respect to one another. That is, when a change such as adding, deleting or editing occurs in the file or the directory or the like of either one of the primary file server devices 1A and 2A and the secondary file server devices 1B and 2B, such a change is updated in the other one of the primary file server devices 1A and 2A and the secondary file server devices 1B and 2B. Accordingly, both the primary file server device and the secondary file server device always hold the same object.

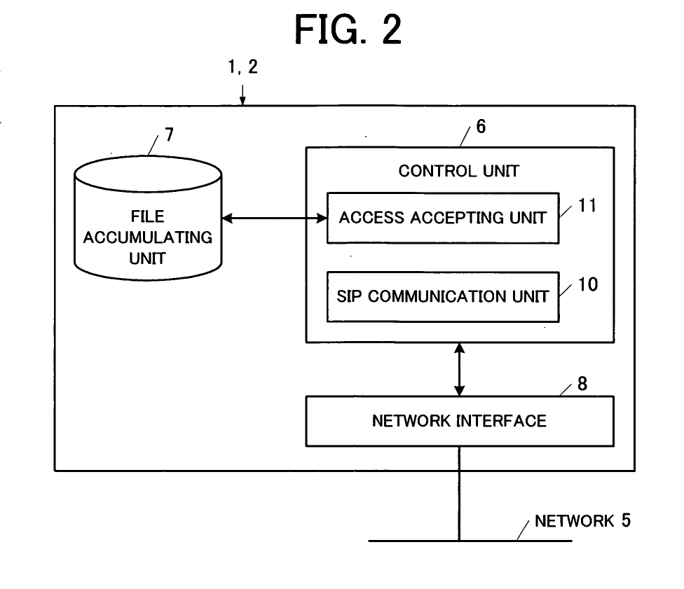

As illustrated in FIG. 2, the file server device 1 (2) includes a control unit 6, a file accumulating unit 7, and a network interface 8 or the like. The control unit 6 includes a Central Processing Unit (CPU), a Read Only Memory (ROM), and a Random Access Memory (RAM) or the like. The file accumulating unit 7 includes a magnetic disk or the like. The network interface 8 connects the file server device 1 (2) to the network 5. The file server device 1 (2) is provided with the SIP and the Session Description Protocol (SDP), and also a communication protocol for receiving access to a file over a data session established by the SIP. That is, the control unit 6 of the file server device 1 (2) includes a SIP communication unit 10 for transmitting and receiving a signaling message according to the SIP by executing a control program stored in the ROM, the RAM or the like. The control unit 6 also functions as an access accepting unit 11 for accepting access to the object stored in the file server device 1 (2) over the data session established by the SIP. That is, when receiving a data session initiation request, the access accepting unit 11 describes an access port number and an IP address or the like in a response message and returns the response message. Further, the access port number and the IP address or the like are information necessary for accessing the object stored in the file server device 1 (2). When a data session is established with a requester, the access accepting unit 11 accepts an access to the object stored in the file server device 1 (2) from the requester. Further, the Hyper Text Transfer Protocol (HTTP) or the like may be adopted as a communication protocol for accessing the object in the established data session.

The file server device 1 (2) includes a requesting unit which requests a SIP registration server 4B (the SIP registration server 4B will be described in detail later) of a communication management server device 4 (a SIP server device 4) to change the IP address of the file server device 1 (2) when the IP address assigned to the file server device 1 (2) has been changed. That is, when the IP address registered in the file server device 1 (2) is changed to a different IP address, the file server device 1 (2) transmits a message to the SIP registration server 4B, and requests the original IP address registered by being associated with an account of the file server device 1 (2) to be changed into the changed IP address. For example, the file server devices 1 and 2 transmit to the SIP registration server 4B, a SIP message “REGISTER” or the like including account information and the changed IP address of the file server device 1 (2), and request the IP address to be updated.

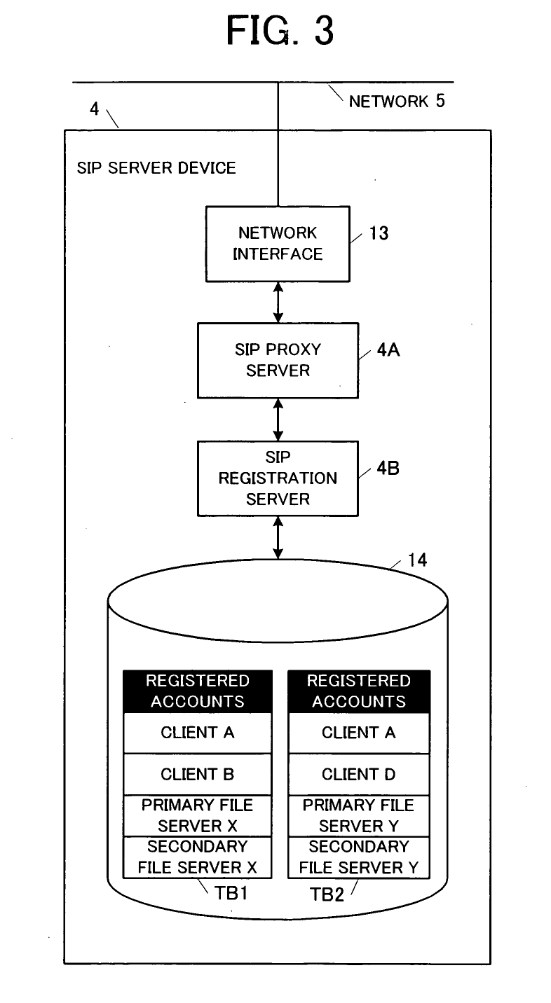

The communication management server device 4 is a server device controlling a call control. In the first preferred embodiment, a SIP server device 4 is the communication management server device 4. As illustrated in FIG. 3, the SIP server device 4 is connected to the network 5 via a network interface 13. The SIP server device 4 includes hardware resources such as a CPU, a ROM, a RAM and a memory device (not illustrated). The SIP server device 4 functions as a SIP proxy server 4A and the SIP registration server 4B by a processing operation executed by the CPU in accordance with a program stored in the ROM, the RAM or the like.

The SIP proxy server 4A receives a SIP message and forwards the received SIP message. Alternatively, without forwarding the received SIP message, the SIP proxy server 4A executes a process for transmitting a response directly to a transmitter of the SIP message.

As illustrated in FIG. 3, the SIP registration server 4B stores account tables TB1 and TB2 into a location memory unit 14, which includes a magnetic disk or the like. Further, each of the account tables TB1 and TB2 stores account information registered in the SIP server device 4 (information associating an account, such as a Uniform Resource Locator (URL) and an IP telephone number, with an IP address). Each of the account tables TB1 and TB2 includes a registration of account information of a pair of file server devices and account information of a plurality of client devices 3. One common group is formed for each account table. The SIP registration server 4B adds, deletes or changes the account information stored in the account table TB1 or TB2 when receiving a prescribed command, for example, the above-described “REGISTER”, from the client device 3, the file server device 1, 2 or the like. Further, in the present preferred embodiment, the SIP proxy server 4A and the SIP registration server 4B are embedded in one computer. However, the SIP proxy server 4A and the SIP registration server 4B may be respectively embedded in different computers and operated in cooperation with one another.

When the SIP proxy server 4A of the SIP server device 4 receives an “INVITE” message, which is a data session initiation request, from the client device 3, the SIP proxy server 4A presents a destination account (for example, an IP telephone number, a URL) and a caller account to the SIP registration server 4B to inquire an IP address. In response to the inquiry, when the presented destination account and the presented caller account are registered in the same account table, the SIP registration server 4B presents an IP address corresponding to the presented destination account to the SIP proxy server 4A. Meanwhile, when the presented destination account information is not registered, or when the destination account and the caller account are not registered in the same account table, the SIP registration server 4B notifies such a fact to the SIP proxy server 4A.

When the SIP proxy server 4A receives the destination IP address from the SIP registration server 4B, the SIP proxy server 4A forwards the “INVITE” message to the destination and also forwards a SIP message subsequently exchanged between the caller and a called side. Meanwhile, when the SIP proxy server 4A receives a notification from the SIP registration server 4B indicating a fact that the destination account information is not registered or that the destination account information and the caller account information are not registered in the same account table, the SIP proxy server 4A returns an error message to the caller client device 3 without forwarding the “INVITE” message.

The network 5 is a LAN, a WAN or a VPN, for example. FIG. 1 illustrates an example in which the network 5 is the LAN.

The client device 3 is a computer, such as a Personal Computer (PC), including an operation system or the like. In addition to the SIP and the SDP, the client device 3 includes a communication function for accessing an object, such as a file and a directory, stored in the file server device 1 or 2 over the data session established by the SIP. Further, the communication function for accessing the object stored in the file server device 1 or 2 may be realized by embedding a browser or the like in the client device 3.

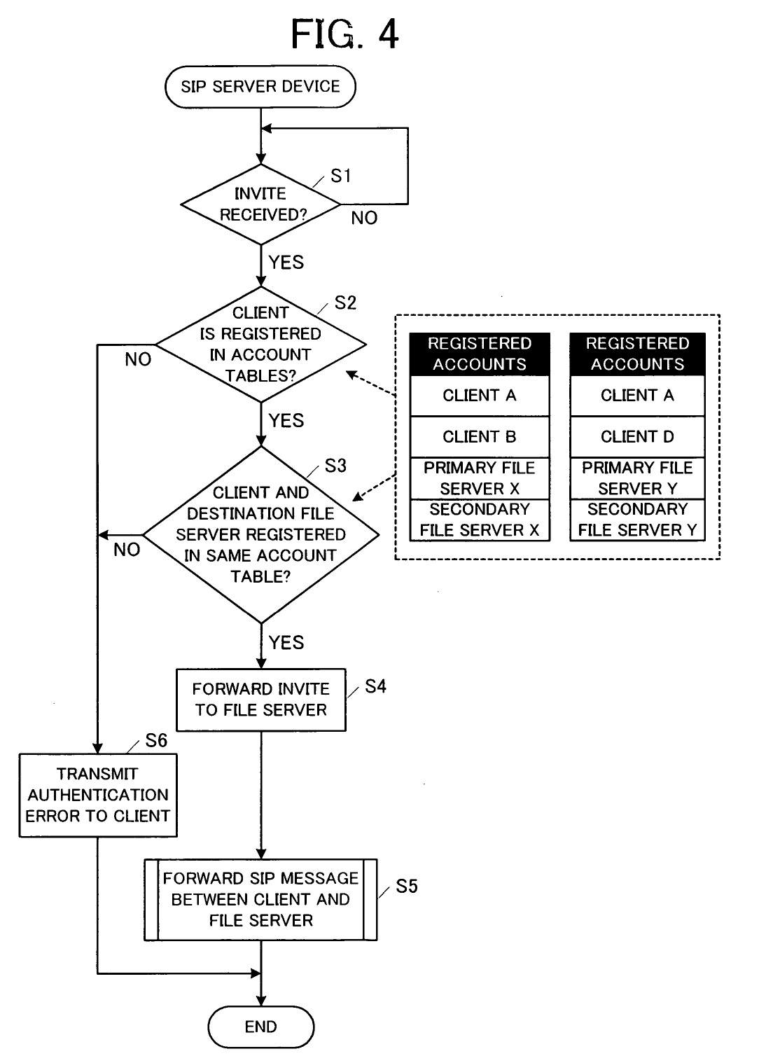

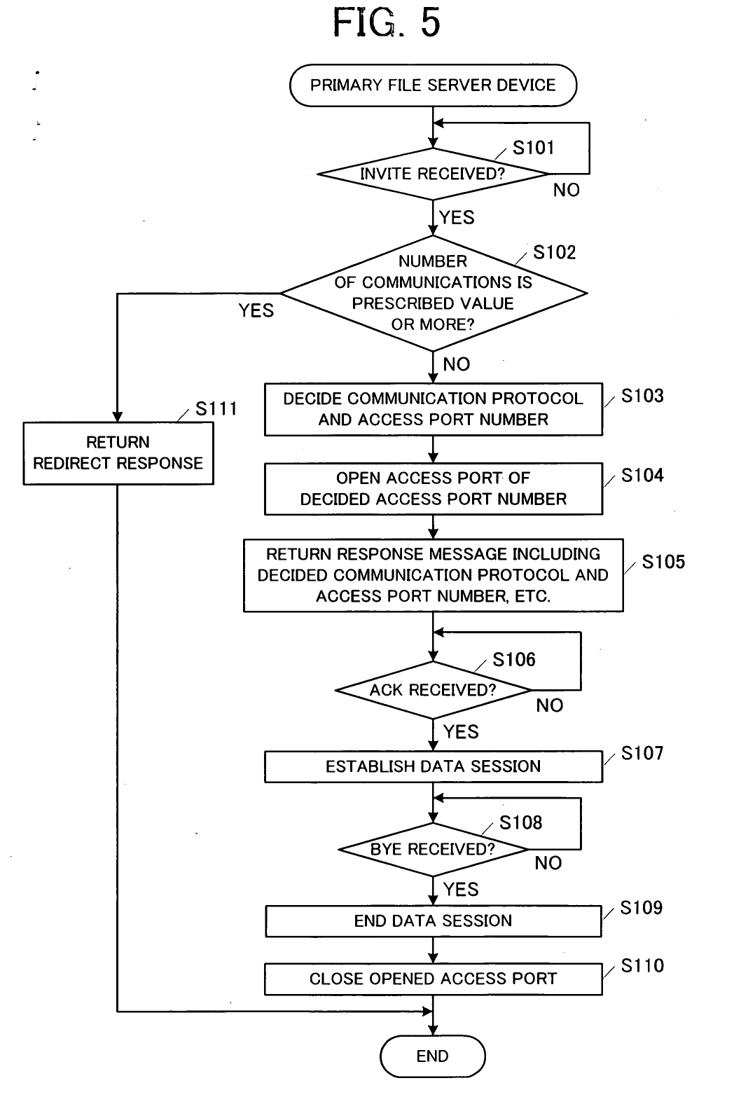

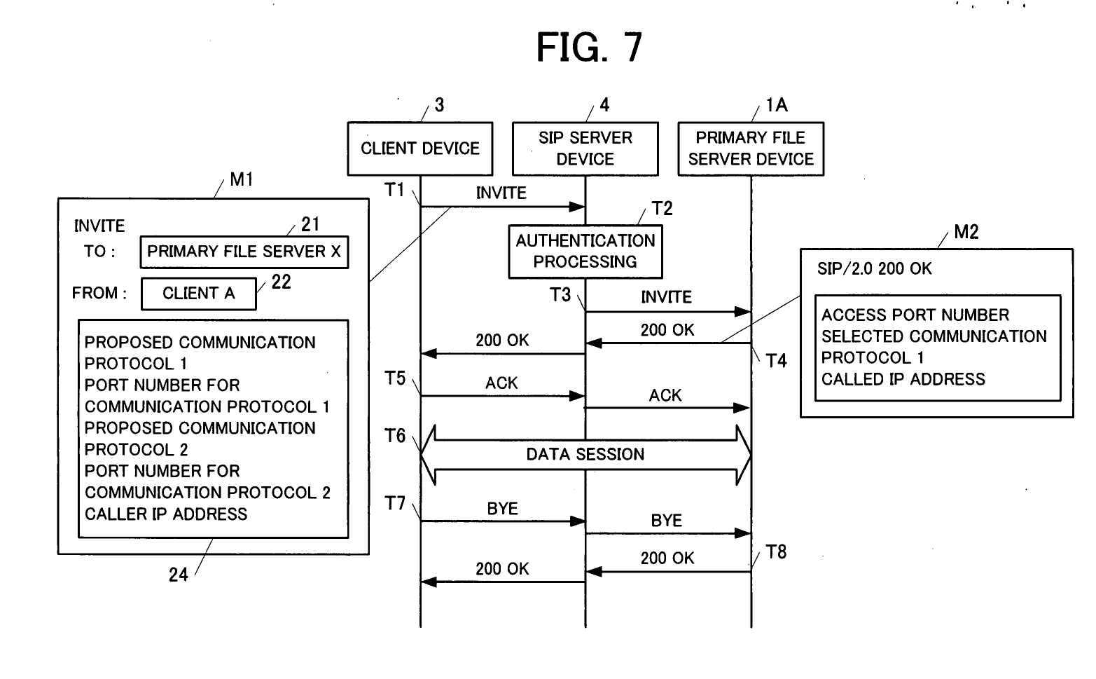

With reference to the flowcharts of FIG. 4 through FIG. 6 and the sequence diagrams of FIG. 7 through FIG. 9, a description will be made of a processing operation of the SIP server device 4 and the file server device 1 or the like executed when the client device 3 requests an access to the object stored in the primary file server device 1A, for example.

When a user of the client device 3 performs a prescribed operation for accessing the primary file server device 1A, as illustrated in FIG. 7, the client device 3 generates an “INVITE” message M1, which is a data session initiation request message including an account 21 (for example, an IP telephone number or a URL) of the primary file server device 1A and an account 22 (for example, an IP telephone number or a URL) of the client device 3. The account 21 of the primary file server device 1A described in the “INVITE” message M1 is input or selected by the prescribed operation performed by the user. As illustrated in FIG. 7, the “INVITE” message M1 also includes session information 24 described by the SDP. The session information 24 proposes the primary file server device 1A one or a plurality of a communication protocol, a communication port number and an IP address of the client device 3 or the like to be used in a data session (media session) for accessing the object (for example, a file or a directory) stored in the primary file server device 1A.

The “INVITE” message M1 generated by the client device 3 is transmitted from the client device 3 to the SIP server device 4 (T1). The SIP server device 4, which received the “INVITE” message M1 (S1: YES), carries out an authentication processing of the client device 3 (T2). Specifically, the SIP server device 4 retrieves the account 22 of the caller client device 3 and the destination account 21 described in the “INVITE” message M1, and determines whether or not the account 22 and the destination account 21 are registered in the account table TB1 or TB2 (S2). When the account 22 and the account 21 are registered (S2: YES), the SIP server device 4 determines whether or not the account 22 of the client device 3 and the destination account 21 (the account of the primary file server device 1A) are registered in the same account table TB1 or TB2 (S3). When the account 21 of the client device 3 and the account 22 of the primary file server device 1A are registered in the same account table TB1 or TB2 (S3: YES), the SIP server device 4 (the SIP proxy server 4A) forwards the received “INVITE” message M1 to the primary file server device 1A, which is the destination (S4, T3).

When the primary file server device 1A receives the “INVITE” message M1 (S101: YES), the primary file server device 1A determines whether or not a communication load of the primary file server device 1A is a prescribed value or more (S102). Specifically, the primary file server device 1A detects a number of data sessions currently established by the primary file server device 1A, and determines whether or not the detected number of data sessions (number of communications) is a prescribed value (for example, 5) or more.

When the primary file server device 1A determines that the communication load is less than the prescribed value (S102: NO), the primary file server device 1A selects and decides a communication protocol proposed in the received “INVITE” message, and decides an access port number at the primary file server device 1A to be used in the data session by the decided communication protocol (S103). The primary file server device 1A previously prepares (memorizes) a plurality of candidates of access port numbers for each communication protocol. The primary file server device 1A selects one access port number from the candidates and decides the access port number to be used. The selection and the decision of the access port number are carried out each time when receiving the “INVITE” message, and the access port number is updated to a different access port number every time. For example, a memory unit of the primary file server device 1A stores a chart in which a plurality of access port numbers are randomly arranged, and the primary file server device 1A sequentially selects an access port number from the access port numbers arranged in the chart and decides the access port number.

After the primary file server device 1A decides the communication protocol and the access port number at S103, the primary file server device 1A opens an access port corresponding to the decided access port number (S104). The primary file server device 1A generates a response message M2 described by the SDP, and returns the response message M2 to the caller (T4, S105). Further, the response message M2 includes information necessary for accessing the object stored in the primary file server device 1A, i.e., the communication protocol decided at S103, and the access port number and the IP address of the primary file server device 1A. The SIP server device 4 forwards the response message M2 to the client device 3 (S5).

After receiving the response message M2, the client device 3 transmits an “ACK” message to the primary file server device 1A through the SIP server device 4 (T5, S5, S106: YES). Then, a data session is established between the client device 3 and the primary file server device 1A, and communication is carried out over the established data session for accessing the object stored in the primary file server device 1A from the client device 3 (T6, S107).

When a prescribed operation is performed for ending the data session (the communication for the access) at the client device 3, the client device 3 transmits a “BYE” message, which is a session termination request message, to the primary file server device 1A via the SIP server device 4 (T7, S5, S108: YES). After a response message “200 OK” is transmitted from the primary file server device 1A via the SIP server device 4 to the client device 3 (T8, S5), the data session is disconnected (S109). Then, the primary file server device 1A closes the opened access port (S110).

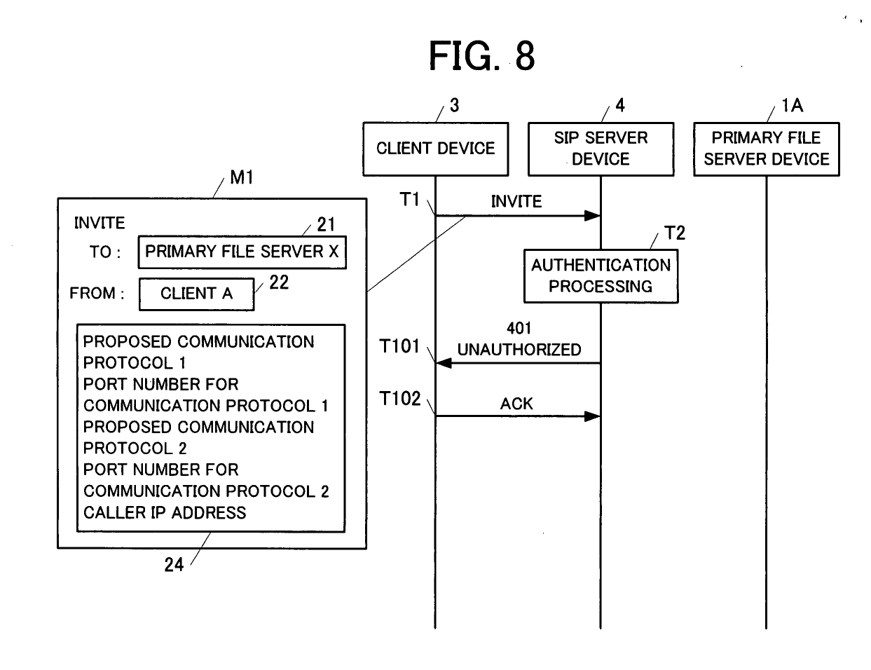

When a determination is made that the account 22 of the caller client device 3 and the destination account 21 are not registered in the account table TB1 or TB2 (S2: NO), or when a determination is made that although both of the accounts 21 and 22 are registered, the account information of the client device 3 and the destination account 21 are not registered in the same account table (S3: NO), as illustrated in FIG. 8 for example, the SIP server device 4 returns a prescribed error message to the client device 3 (S6, T101). For example, the prescribed error message is an authentication error message “401”. The client device 3 returns an “ACK” message as a response to the error message (T102). As a result, a common group is formed by only the file server device and the client device registered in the same table. A user having an account not registered in the same table as the account of the file server device is prohibited from accessing such file server device. For example, in the account tables illustrated in FIG. 3, one common group is formed by terminals having an account of “CLIENT A”, “CLIENT B”, “PRIMARY FILE SERVER X” and “SECONDARY FILE SERVER X”, and another one group is formed by terminals having an account of “CLIENT A”, “CLIENT D”, “PRIMARY FILE SERVER Y” and “SECONDARY FILE SERVER Y”. In this case, the client device 3 having the account of the “CLIENT B” cannot access the primary file server device 2A having the account of the “PRIMARY FILE SERVER Y”.

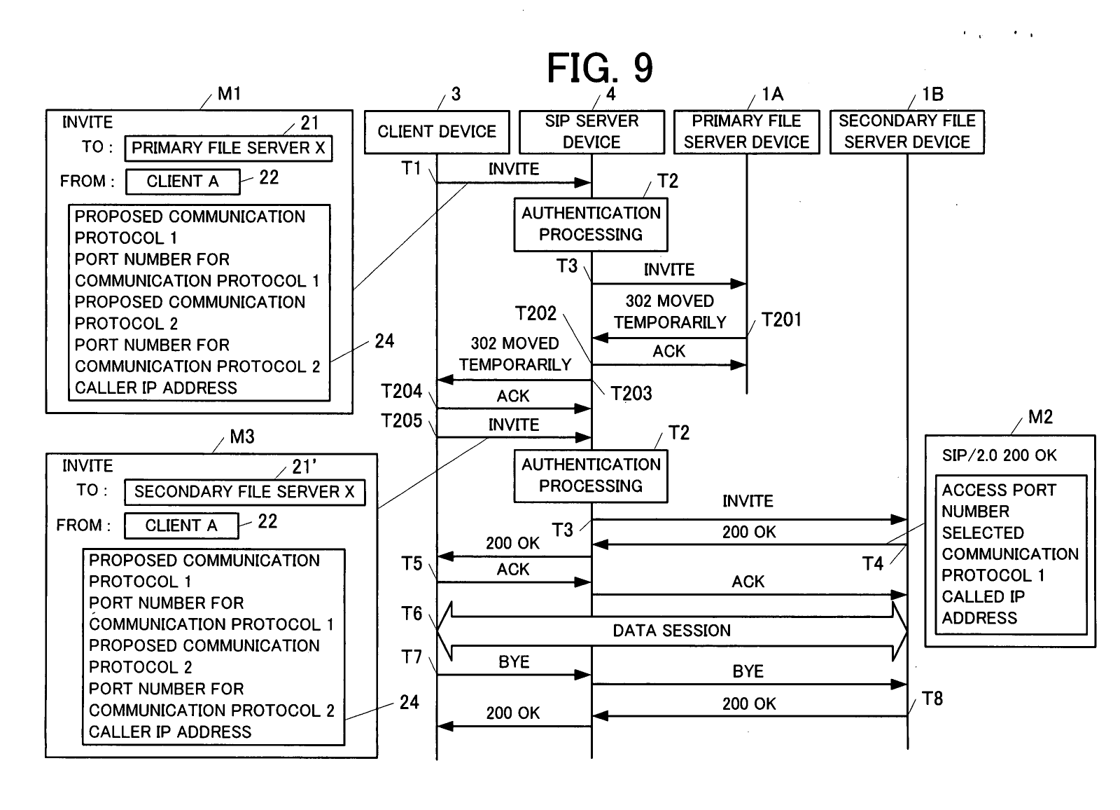

When a determination is made at S102 that the communication load of the primary file server device 1A is the prescribed value or more (S102: YES), the primary file server device 1A generates a redirect response message “302” and returns the generated redirect response message “302” to the caller client device 3 (S111, T201; refer to FIG. 9). Further, the redirect response message “302” includes the account information of the secondary file server device 1B previously registered in the primary file server device 1A. After receiving the redirect response message “302”, the SIP server device 4 transmits an “ACK” message to the primary file server device 1A (T202) and forwards the redirect response message “302” to the caller client device 3 (T203).

After receiving the redirect response message “302”, the client device 3 returns an “ACK” message to the SIP server device 4 (T204). The client device 3 retrieves an account 21′ of the secondary file server device 1B designated in the redirect response message “302” as a device accepting an access in place of the primary file server device 1A. The client device 3 generates an “INVITE” message M3 in which the account 21′ is described as a destination. Then, the client device 3 transmits the “INVITE” message M3 to the secondary file server device 1B (T205). Further, the contents of the “INVITE” message M3 are the same as the contents of the previously transmitted “INVITE” message M1 except for having the account 21′ as the destination.

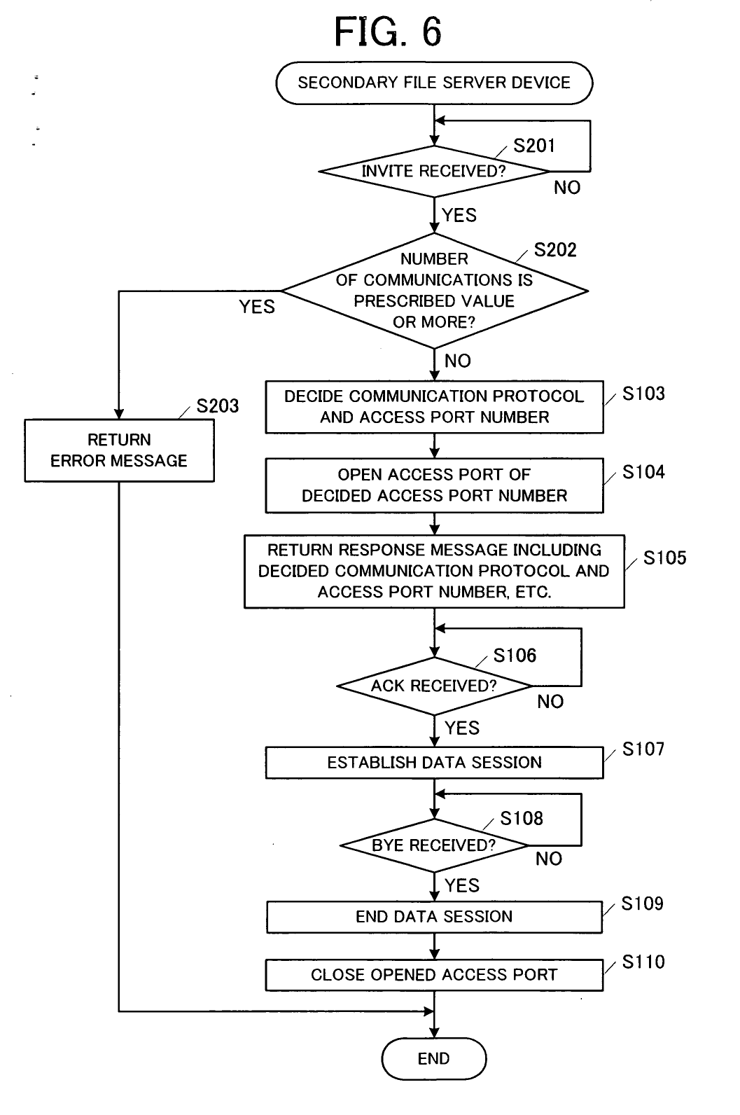

As illustrated in FIG. 6, when the secondary file server device 1B receives the “INVITE” message M3 (S201: YES), the secondary file server device 1B determines whether or not a communication load of the secondary file server device 1B is a prescribed value or more (S202). Specifically, the secondary file server device 1B detects a number of sessions established by the secondary file server device 1B, and determines whether or not the detected number of sessions is a prescribed value or more. When the secondary file server device 1B determines that the detected communication load is less than the prescribed value (S202: NO), the secondary file server device 1B executes the processing operation that is the same as the processing operation of S103 through S110 described above with regard to the primary file server device 1A. In this case, the SIP server device 4 and the client device 3 also execute the above-described processing operation according to the processing operation carried out by the secondary file server device 1B (T2 through T8). Meanwhile, when the secondary file server device 1B determines that the detected communication load is the prescribed value or more (S202: YES), the secondary file server device 1B returns a prescribed error message to the client device 3 via the SIP server device 4 for notifying a fact that an access to the file or the like cannot be accepted (S203). Further, FIG. 9 illustrates only an example when a determination of NO is made at S202.

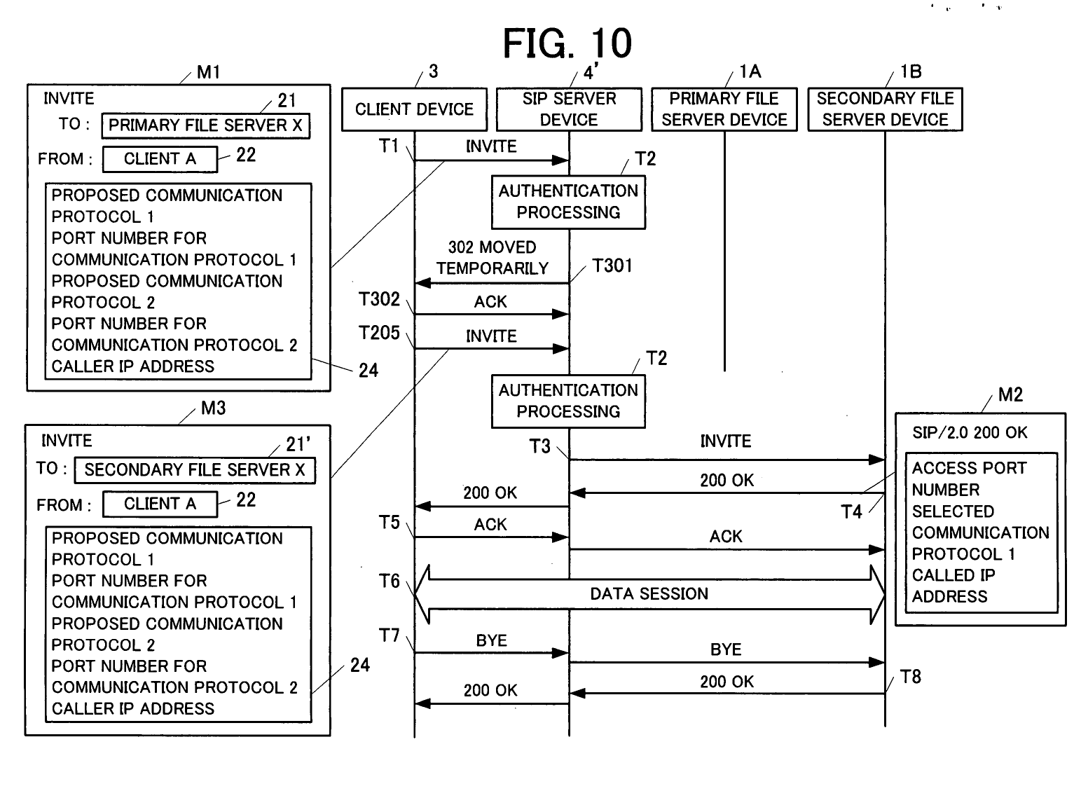

With reference to FIG. 10 through FIG. 12, a description will be made of a second preferred embodiment of the present invention. Further, for the same constitution and the same processing operation as the first preferred embodiment, like numerals are assigned in the drawings and a description will be omitted. A description will be made primarily of a difference.

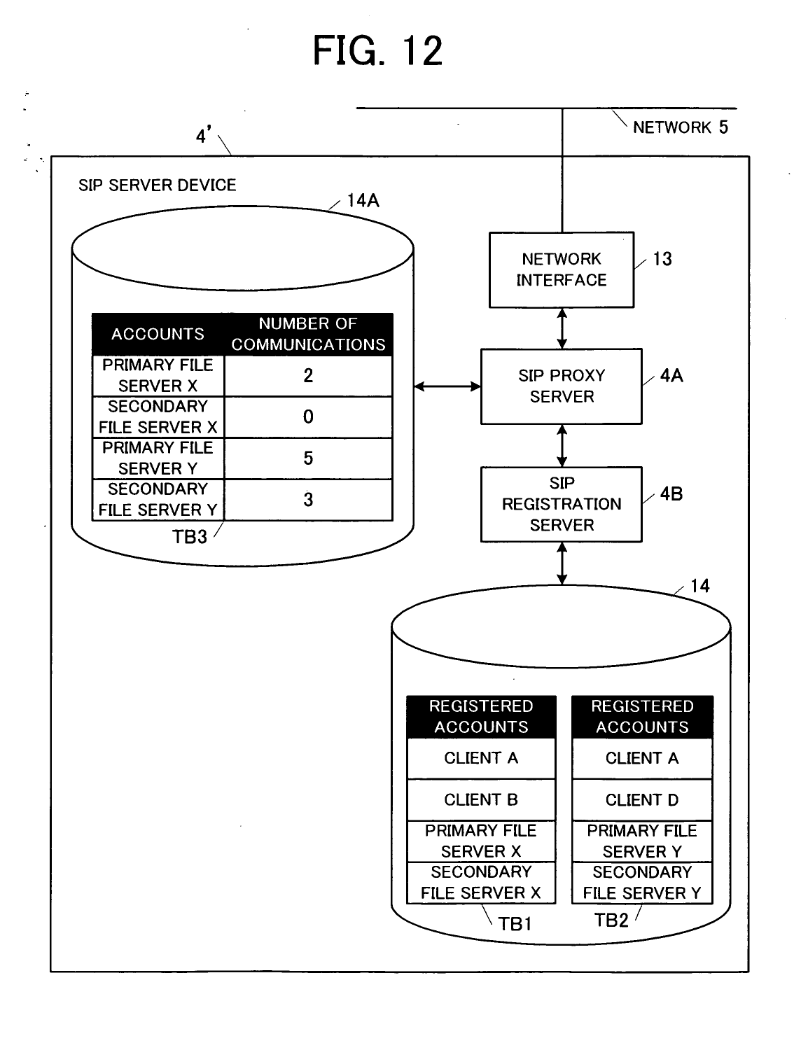

As illustrated in FIG. 12, a SIP server device 4′ according to the second preferred embodiment includes the SIP proxy server 4A. The SIP proxy server 4A monitors a number of data sessions established by each fileserver. When the monitored number of data sessions exceeds a prescribed value, the SIP proxy server 4A prohibits forwarding of an “INVITE” message. Therefore, the SIP proxy server 4A of the SIP server device 4′ includes a memory unit 14A such as a memory. The memory unit 14A includes a communication number management table TB3. The communication number management table TB3 counts a number of currently established data sessions for each account of each of the file server devices 1A, 1B, 2A and 2B, and stores the counted number. Further, the monitoring of the number of the established data sessions is carried out by detecting the forwarding of an “INVITE” message and an “ACK” message carried out when establishing a data session and the forwarding of a “BYE” message carried out when ending the data session.

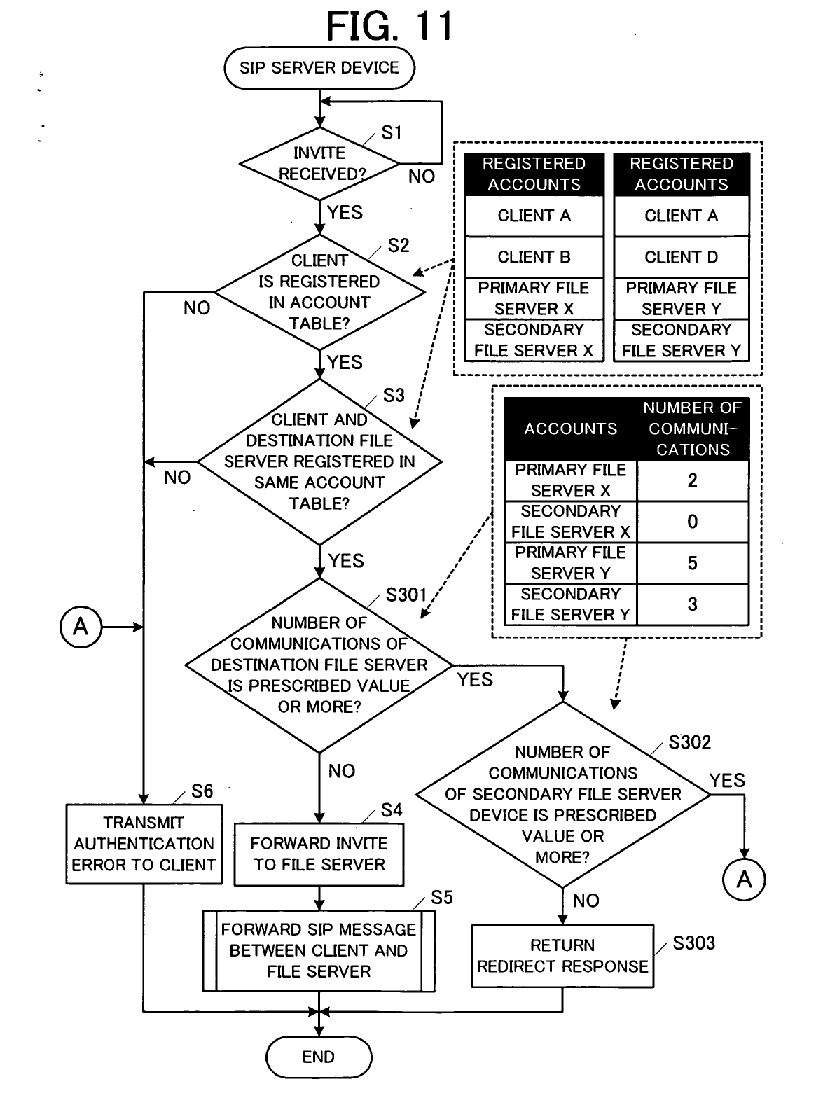

As illustrated in the flowchart of FIG. 11, the SIP server device 4′ receives the “INVITE” message (S1: YES). When a positive determination is made at S2 and S3 (S2: YES and S3: YES), the SIP server device 4′ determines whether or not a communication load of the primary file server device 1A, which is a destination of the “INVITE” message, is a prescribed value or more (S301). Specifically, the SIP server device 4′ refers to the communication number management table TB3 managed by the SIP proxy server 4A of the SIP server device 4′, and determines whether or not a number communications currently established by the primary file server device 1A of the destination is a prescribed value (for example, 5) or more.

When a determination is made at S301 that the communication load of the primary file server device 1A, which is the destination of the “INVITE” message, is less than the prescribed value (S301: NO), the processing operation of S4 and S5 described in the first preferred embodiment is executed.

Meanwhile, when a determination is made that the communication load of the primary file server device 1A, which is the destination of the “INVITE” message, is the prescribed value or more (S301: YES), the SIP server device 4′ determines whether or not a communication load of the secondary file server device 1B of the primary file server device 1A is a prescribed value or more (S302). This determination is also carried out in the same manner, i.e., by referring to the communication number management table TB3 stored in the SIP server device 4′ and determining whether or not the number of communications currently established by the secondary file server device 1B is the prescribed value (for example, 5) or more.

When a determination is made at S302 that the communication load of the secondary file server device 1B is less than the prescribed value (S302: NO), the SIP server device 4′ generates a redirect response message “302” including the account of the secondary file server device 1B, and returns the generated redirect response message “302” to the caller client device 3 (S303, T301; refer to FIG. 10).

After receiving the redirect response message “302”, the client device 3 transmits an “ACK” message to the SIP server device 4′ (T302). Then, the client device 3 retrieves the account information of the secondary file server device 1B designated in the redirect response message “302” as a device for accepting an access in place of the primary file server device 1A. The client device 3 generates an “INVITE” message M3 in which the account 21′ is described as a destination. The client device 3 transmits the generated “INVITE” message M3 to the secondary file server device 1B (T205). Then, the communication procedure that is the same as the first preferred embodiment is formed between the client device 3, the SIP server device 4′ and the secondary file server device 1B (T2 through T8).

In the above-described first and second preferred embodiments of the present invention, the primary file server device 1A and the secondary file server device 1B are provided in separate computers. The present invention is not limited to such an example. For example, a plurality of directories may be formed in one computer, and different account information may be assigned to each of the directories to be functioned as a primary file server device or a secondary file server device respectively.

As described above, according to the SIP server device and the file server device of the preferred embodiments of the present invention, the account of the client device is registered in the SIP server device. Therefore, the account of the client device is not required to be stored in the file server device. Thus, the registering, the deleting and the changing or the like of the account of each client device can be uniformly managed just by the SIP server device. Furthermore, the account information of the file server device and a plurality of client devices, which have been grouped together, are collectively registered in a table stored in a registration server of the SIP server device, and a group sharing the file server device is formed. Therefore, even when the file server device is shared via the WAN or the VPN, a setting operation required just for registering a common group, for example, a setting of the NAT or a firewall or the like, becomes unnecessary. The burden of the setting operation required when newly installing or moving the file server device is reduced. In particular, when moving the file server device, it is just necessary to change the IP address of the file server device registered in the account table stored in the registration server of the SIP server. Since this change can be made at a remote location located away from the file server device, the burden of the setting operation required when moving the file server device is reduced considerably.

The file server device according to the preferred embodiments of the present invention notifies an access port to a requester when receiving the data session initiation request. Therefore, an unused access port can be closed normally, and the access port can be opened only when the file or the like is being accessed from the client device. As a result, security is improved. Furthermore, the file server device changes the access port each time when receiving an access request from the client device. As a result, security is improved even more.

The file server device includes the primary file server device and the secondary file server device. When the primary file server device receives the access request under a state in which the communication load of the primary file server device is high, the primary file server device executes a redirect response so that the secondary file server device accepts a file access in place of the primary file server device. As a result, the communication load can be dispersed by a simple constitution.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the present invention.

What is claimed is:

1. A file server device including a communication function using a call control protocol, the file server device comprising:
means for returning a response message, which includes information necessary for accessing an object stored in the file server device, when receiving a data session initiation request by the call control protocol; and
means for establishing a data session with a requester of the data session initiation request and accepting access to the object stored in the file server device in the established data session.

2. The file server device according to claim 1, wherein the information necessary for accessing the object stored in the file server device includes an access port number, and
the file server device further comprises means for switching a state of a port of the access port number included in the response message into an opened state when establishing the data session, and switching the opened state of the port of the access port number into a closed state when terminating the data session.

3. The file server device according to claim 2, wherein the means for switching updates the access port number of the port to be switched into the opened state each time when receiving the data session initiation request.

4. The file server device according to claim 1, further comprising means for notifying a requestor of the data session initiation request, a fact that a different device will accept an access in place of the file server device and destination information of the different device having a copy of the object stored in the file server device, when a communication load of the file server device is a prescribed value or more at a reception of the data session initiation request.

5. The file server device according to claim 2, further comprising means for notifying a requester of the data session initiation request, a fact that a different device will accept an access in place of the file server device and destination information of the different device having a copy of the object stored in the file server device, when a communication load of the file server device is a prescribed value or more at a reception of the data session initiation request.

6. The file server device according to claim 3, further comprising means for notifying a requester of the data session initiation request, a fact that a different device will accept an access in place of the file server device and destination information of the different device having a copy of the object stored in the file server device, when a communication load of the file server device is a prescribed value or more at a reception of the data session initiation request.

7. A communication management server device comprising:
means for storing account information of a file server device and account information of a plurality of devices sharing the file server device in a same table, and memorizing the table; and
means for forwarding a data session initiation request addressed to the file server device only when account information of a requestor of the data session initiation request and the account information of the file server device are stored in the same table at a reception of the data session initiation request.

8. A file server device including a communication function using a call control protocol, the file server device comprising:
a reply unit which returns a response message, which includes information necessary for accessing an object stored in the file server device, when receiving a data session initiation request by the call control protocol; and
an access accepting unit which establishes a data session with a requester of the data session initiation request, and accepts access to the object stored in the file server device in the established data session.

9. The file server device according to claim 8, wherein the information necessary for accessing the object stored in the file server device includes an access port number, and
the file server device further comprises an access port opening and closing unit which switches a state of a port of the access port number included in the response message into an opened state when establishing the data session and switches the opened state of the port of the access port number into a closed state when terminating the data session.

10. The file server device according to claim 9, wherein the access port opening and closing unit updates the access port number of the port to be switched into the opened state each time when receiving the data session initiation request.

11. The file server device according to claim 8, further comprising a notification unit which notifies a requestor of the data session initiation request, a fact that a different device will accept an access in place of the file server device and destination information of the different device having a copy of the object stored in the file server device, when a communication load of the file server device is a prescribed value or more at a reception of the data session initiation request.

12. The file server device according to claim 9, further comprising a notification unit which notifies a requestor of the data session initiation request, a fact that a different device will accept an access in place of the file server device and destination information of the different device having a copy of the object stored in the file server device, when a communication load of the file server device is a prescribed value or more at a reception of the data session initiation request.

13. The file server device according to claim 10, further comprising a notification unit which notifies a requester of the data session initiation request, a fact that a different device will accept an access in place of the file server device and destination information of the different device having a copy of the object stored in the file server device, when a communication load of the file server device is a prescribed value or more at a reception of the data session initiation request.

14. A communication management server device comprising:
a memory unit which stores account information of a file server device and account information of a plurality of devices sharing the file server device in a same table, and memorizes the table; and
a forwarding unit which forwards a data session initiation request addressed to the file server device only when account information of a requester of the data session initiation request and the account information of the file server device are stored in the same table at a reception of the data session initiation request.

15. A network system, comprising:
a file server device;
a communication management server device; and
a plurality of devices sharing the file server device.
wherein the file server device includes:
a communication function using a call control protocol,
a reply unit which returns a response message, which includes information necessary for accessing an object stored in the file server device, when receiving a data session initiation request by the call control protocol, and
an access accepting unit which establishes a data session with a requester of the data session initiation request, and accepts access to the object stored in the file server device in the established data session; and
the communication management server device includes:
a memory unit which stores account information of a file server device and account information of the plurality of devices sharing the file server device in a same table, and memorizes the table; and
a forwarding unit which forwards a data session initiation request addressed to the file server device only when the account information of the requestor and the account information of the file server device are stored in the same table at a reception of the data session initiation request.
